(19) United States
(12) Patent Application Publication
(10) Pub. No.: US 2021/0182179 A1
(43) Pub. Date: Jun. 17, 2021

(54) ONLINE TESTING SYSTEM AND TESTING METHOD FOR COMPUTER PROGRAM

(71) Applicant: INDUSTRIAL TECHNOLOGY RESEARCH INSTITUTE, Hsinchu (TW)

(72) Inventors: Jiazheng ZHOU, Taipei City (TW); Chao-Chun YEH, Kaohsiung City (TW); Xuan-Yi LIN, Taichung City (TW); Su-Shen HUNG, Hsinchu City (TW)

(73) Assignee: INDUSTRIAL TECHNOLOGY RESEARCH INSTITUTE, Hsinchu (TW)

(21) Appl. No.: 16/713,286

(22) Filed: Dec. 13, 2019

(51) Int. Cl. G06F 11/36

(52) U.S. Cl. CPC G06F 11/3664; G06F 11/3692; G06F 11/3688

(57) ABSTRACT

The present invention discloses an online testing system and a testing method for computer programs. The online testing system includes a communication unit, a storage unit and an operation unit. The communication unit is configured to connect with an external device, and receive a computer program from the external device. The storage unit is configured to store a raw data, a program execution module, a data generation module and an evaluation module. When the computer program is received, the operation unit is configured to: perform the data generation module to generate a testing data and a solution corresponding to the testing data according to the raw data; perform the program execution module to execute the computer program based on the testing data for generating an execution result; and perform the evaluation module to generate a score according to the execution result and the solution.

### TECHNICAL FIELD

The disclosure relates in general to an online testing system and a testing method for computer programs.

### BACKGROUND

At times, government agencies or business entities may commission programming projects to external program developers. During the developing stage of programming, a commissioned program developer may normally ask its commissioner to provide testing data to evaluate whether the developed program meets the commissioner's requirements or not. However, due to the consideration of the Privacy Act or business secrets, it is not convenient for a commissioner to provide some sensitive data, such as clients' medical histories, bank account data, historic transaction data or taxation data, to its developer. Currently, the online testing method is commonly used. The program developer uploads the to-be-tested program to an online testing platform. The online testing platform will provide a score to the program developer, who will use the score as a basis for improvement. However, the above method is not risk free. The ill-intentioned still could add particular mechanisms to the program to steal sensitive data through several times of uploading and analyzing the evaluation result.

### SUMMARY

According to one embodiment, an online testing system for computer programs is disclosed. The online testing system has a closed operating environment, and includes a communication unit, a storage unit and an operation unit. The communication unit is configured to connect with an external device, and receive a computer program from the external device. The storage unit is configured to store a raw data, a program execution module, a data generation module and an evaluation module. The operation unit is coupled to the communication unit and the storage unit. When the computer program is received, the operation unit is configured to: perform the data generation module to generate a testing data and a solution corresponding to the testing data according to the raw data; perform the program execution module to execute the computer program to generate an execution result according to the testing data; and perform the evaluation module to generate a score according to the execution result and the solution.

According to another embodiment, an online testing method for computer programs is disclosed. The online testing is applicable to an online testing system having a closed operating environment, and includes: receiving a computer program from an external device by a communication unit of the online testing system; performing a data generation module by an operation unit of the online testing system to generate a testing data and a solution corresponding to the testing data according to a raw data stored in a storage unit of the online testing system; performing a program execution module by the operation unit to execute the computer program to generate an execution result according to the testing data; and performing an evaluation module by the operation unit to generate a score according to the execution result and the solution.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of an online testing system for computer programs according to an embodiment of the present invention.

FIG. 2 is a flowchart of an online testing method for computer programs according to an embodiment of the present invention.

FIG. 3 is a flowchart of an online testing method for computer programs according to another embodiment of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

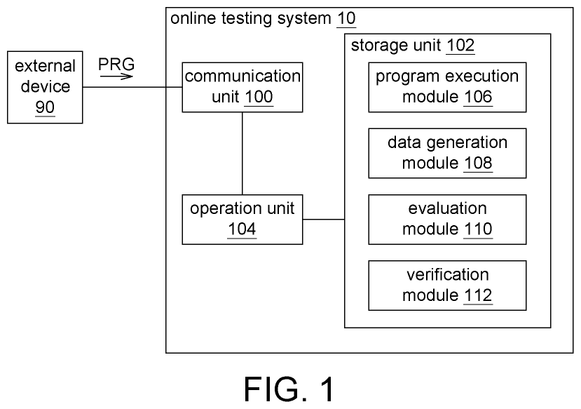

Referring to FIG. 1, a block diagram of an online testing system for computer programs according to an embodiment of the present invention is shown. The online testing system 10 includes a communication unit 100, a storage unit 102, an operation unit 104, a data generation module 108, and an evaluation module 110. The online testing system 10 has a closed operating environment which restricts the access from external networks. For example, external networks are only allowed to upload data, but are not allowed to download or read part or all of the data from the online testing system 10.

The communication unit 100 is configured to connect with an external device 90 through wireless or wired connection to transmit or receive messages or data with the external device 90. The communication unit 100 could be implemented by a general-purpose communication chip or a special-purpose communication chip.

The storage unit 102 could be any fixed or movable random access memory (RAM), read-only memory (ROM), flash memory, phase change memory, hard disk drive (HDD), register, solid state drive (SSD) or similar elements or a combination thereof. In the present embodiment, the storage unit 102 refers to an assembly of memory devices configured to store data and computer instructions, and the number and the types of the memory devices are not specified. The storage unit 102 could store a raw data.

The operation unit 104 is coupled to the communication unit 100 and the storage unit 102. The operation unit 104 could be implemented by a central processing unit (CPU), or other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA) or other similar elements or a combination thereof.

The program execution module 106, the data generation module 108 and the evaluation module 110 could be realized by computer readable instructions and could be stored in the storage unit 102. The operation unit 104 performs the data generation module 108 and the evaluation module 110 stored in the storage unit 102 to realize the functions of the data generation module 108 and the evaluation module 110.

The program execution module 106 is configured to execute a computer program PRG uploaded from the external device 90.

The data generation module 108 is configured to generate a testing data and a solution corresponding to the testing data according to the raw data. The data generation module 108 could generate the testing data by way of shuffling and/or sampling. Suppose the raw data has 100 items of data composed of the first item to the 100^{th} item of data. In the embodiment in which the data generation module 108 generates the testing data by way of shuffling, the data generation module 108 could arrange the 100 items of data at random to generate the testing data. In the embodiment in which the data generation module 108 generates the testing data by way of sampling, the data generation module 108 could select 90 items from the 100 items of data to generate the testing data. In the embodiment in which the data generation module 108 generates the testing data by way of shuffling and sampling, the data generation module 108 could select 90 items from the 100 items of data and then arrange the 90 selected items of data at random to generate the testing data. The “solution” refers to the expected result of the computer program PRG executed according to the testing data. For example, suppose the testing data includes 100 pictures. The solution refers to the objects (such as persons, vehicles or motor bikes) respectively shown in the 100 pictures. The purposes of the testing data and the solution are disclosed below.

The evaluation module 110 is configured to execute the computer program PRG uploaded from the external device 90 to generate a score corresponding to the testing data according to an execution result and a solution generated according to the testing data, and transmit the score to the external device 90.

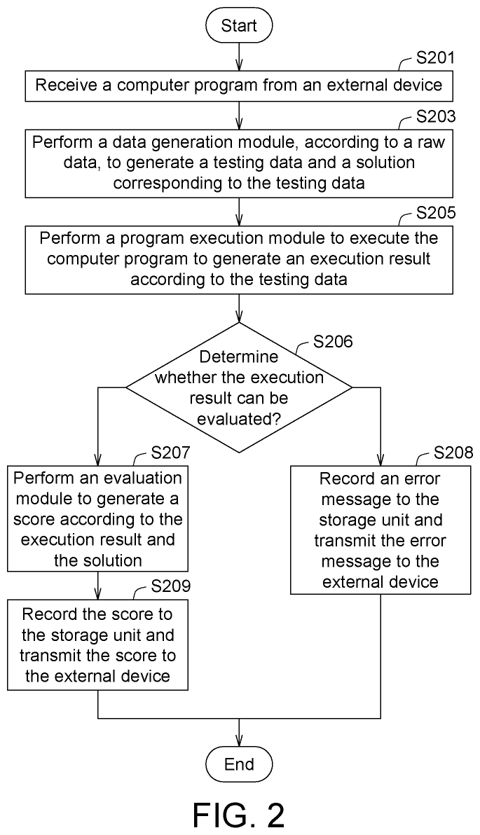

Refer to FIG. 2 to gain a better understanding of the present invention. FIG. 2 is a flowchart of an online testing method for computer programs according to an embodiment of the present invention. The testing method could be used in the online testing system 10.

In step S201, a computer program PRG is received from an external device 90 by the communication unit 100. The computer program PRG could be a program compiled in a programming language such as Python, Java, R, Julia, Matlab, Octave, Scheme, Processing, Scala, C, C++ or assembler. In an embodiment, the computer program PRG uploaded from the external device 90 is stored to the storage unit 102.

In step S203, the data generation module 108 is performed by the operation unit 104 to generate a testing data and a solution corresponding to the testing data according to the raw data.

In step S205, the program execution module 106 is performed by the operation unit 104 to execute the computer program according to the testing data PRG and generate an execution result. Each time when the computer program PRG is uploaded from the external device 90, the data generation module 108 generates different testing data and solutions to avoid the raw data being used directly to reduce the risk of the raw data being stolen.

In an embodiment, the operation unit 104 executes the computer program PRG by an agent program, and the computer program PRG is executed according to the testing data instead of the raw data. For example, when the operation unit 104 performs the program execution module 106, the operation unit 104 is enabled to call an agent program stored in the storage unit 102, and executes the computer program PRG by the agent program. Thus, the program execution module 106 could fully control the execution state of the computer program PRG and confines the computer program PRG to an environment with restricted authority of access. Once the computer program PRG generates any malicious behavior, the program execution module 106 will terminate the agent program to force the computer program PRG to terminate, such that the computer program PRG will not cause damage to the online testing system 10. In a practical example, when the computer program PRG is compiled with Java, the agent program could be an actuator for executing Java programs.

In step S207, the evaluation module 110 is performed by the operation unit 104 to generate a score according to the execution result and the solution. In general, the execution result and the solution have the same format to merit evaluation. However, under certain circumstances, such as program design having errors, the format of the execution result generated by the computer program PRG does not match that of the solution, and the evaluation module 110 will be unable to evaluate the execution result whose format does not match that of the solution. Thus, before step S207 is performed, the method further includes step S206, in which a verification module 112 of the online testing system 10 is performed by the operation unit 104 to determine whether the execution result could be evaluated, that is, to determine whether the format of the execution result matches that of the solution. The verification module 112 could be realized by an assembly of computer readable instructions and could be stored in the storage unit 102. When the operation unit 104 executes the computer readable instructions, the function of the verification module 112 could be realized. If it is determined that the execution result could be evaluated, the method proceeds to step S207. If it is determined that the execution result cannot be evaluated, the method proceeds to step S208. In an embodiment, the score could be based on accuracy. For example, when the testing data includes 100 items of data, the execution result with correct format will include 100 results corresponding to the 100 items of data. The evaluation module 110 compares the 100 results with 100 correct answers (the ground truth) of the solution corresponding to the 100 items of data, and calculates the accuracy to generate the score. For example, if 90 of the 100 results match the solution, the accuracy is 90%, and the score is 0.9.

In step S208, an error message is recorded to the storage unit 102 by the operation unit 104, and is transmitted to the external device 90 through the communication unit 100.

In step S209, the score is recorded to the storage unit 102 by the operation unit 104, and is transmitted to the external device 90 through the communication unit 100.

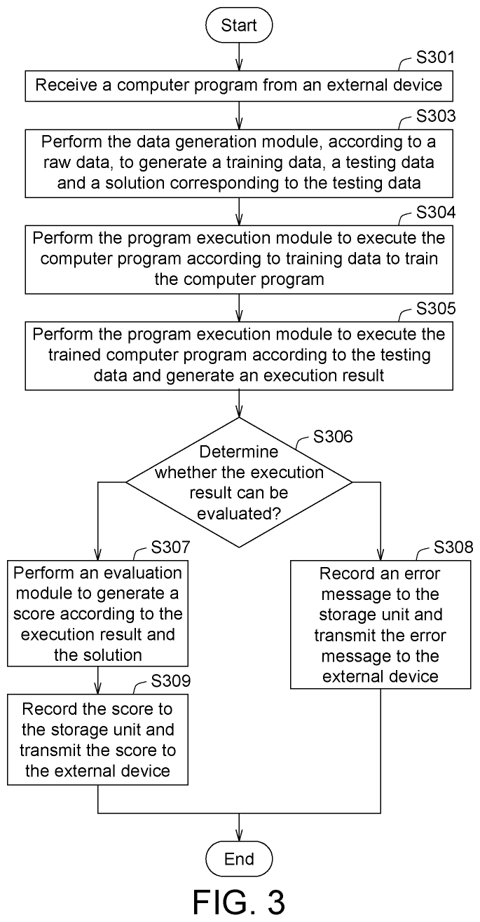

Referring to FIG. 3, a flowchart of an online testing method for computer programs according to another embodiment of the present invention is shown. The method of the present embodiment could be used to test the computer program PRG based on machine learning.

In step S301, a computer program PRG is received from an external device 90 by the communication unit 100. The computer program PRG could be a program based on machine learning.

In step S303, the data generation module 108 is performed by the operation unit 104 to generate a training data according to the raw data, a testing data and a solution corresponding to the testing data. In an embodiment, the data generation module 108 divides the raw data into a first portion and a second portion. The data generation module 108 generates a training data according to the first portion. For example, the data generation module 108 uses the first portion as a training data; or, the data generation module 108 generates a training data according to the first portion by way of shuffling and/or sampling. On the other hand, the data generation module 108 generates a testing data and a solution corresponding to the testing data according to the second portion by way of shuffling and/or sampling as disclosed above. In an embodiment, each time when the computer program PRG is uploaded, the training data could be the same. That is, the training data generated by the computer program PRG uploaded for the first time could be used for the training of the computer program uploaded latter. In another embodiment, the computer program PRG generates a new training data each time when the computer program PRG is uploaded.

In step S304, the program execution module 106 is performed by the operation unit 104 to execute the computer program PRG according to training data to train the computer program PRG.

In step S305, the program execution module 106 is performed by the operation unit 104 to execute the trained computer program PRG according to the testing data and generate an execution result. In an embodiment, the operation unit 104 executes the computer program PRG by an agent program, and the computer program PRG is executed according to the testing data instead of the raw data. Each time when the computer program PRG is uploaded from the external device 90, the data generation module 108 generates different testing data and solutions to avoid the raw data being used directly and reduce the risk of the raw data being stolen.

In step S307, the evaluation module 110 is performed by the operation unit 104 to generate a score according to the execution result and the solution. In general, the execution result and the solution have the same format to merit evaluation. However, under certain circumstances, such as program design having errors, the format of the execution result generated by the computer program PRG does not match that of the solution, and the evaluation module 110 will be unable to evaluate the execution result whose format does not match that of the solution. Thus, before step S307 is performed, the method further includes step S306, in which a verification module 112 of the online testing system 10 is performed by the operation unit 104 to determine whether the execution result could be evaluated, that is, to determine whether the format of the execution result matches that of the solution. If it is determined that the execution result could be evaluated, the method proceeds to S307. If it is determined that the execution result cannot be evaluated, the method proceeds to S308. The method for calculating the score could be obtained with reference to above disclosure.

In step S308, an error message is recorded to the storage unit 102 by the operation unit 104, and is transmitted to the external device 90 through the communication unit 100.

In step S309, the score is recorded to the storage unit 102 by the operation unit 104, and it transmitted to the external device 90 through the communication unit 100.

Under the premise that the raw data is not stolen, the present invention could evaluate the computer program and provide the evaluation result to the external device. In practical application, the present invention could be used in online programming competition. The participants of the competition could upload the computer program for evaluation several times, and could use the evaluation result as a basis for improving the computer program. The participants cannot access the raw data directly. Furthermore, since the online testing system does not test the computer program according to the raw data, the ill-intentioned cannot steal the raw data through uploaded computer programs and evaluation results.

It will be apparent to those skilled in the art that various modifications and variations could be made to the disclosed embodiments. It is intended that the specification and examples be considered as exemplary only, with a true scope of the disclosure being indicated by the following claims and their equivalents.

1. An online testing system for computer programs, wherein the online testing system has a closed operating environment, and comprises:
a communication chip configured to connect with an external device, and receive a computer program from the external device;
one or more memory devices configured to store a raw data, a program execution module, a data generation module and an evaluation module;
an operation unit coupled to the communication and the one or more memory devices,
wherein when the computer program is received, the operation unit is configured to perform the data generation module to generate a testing data and a solution corresponding to the testing data according to the raw data; perform the program execution module to execute the computer program to generate an execution result according to the testing data; and perform the evaluation module to generate a score according to the execution result and the solution,
wherein the method by which the data generation module generates the testing data is:
shuffling the raw data;
extracting part from raw data in quantity; or
a combination of the above.

2. The online testing system according to claim 1, further comprising a verification module performed by the operation unit to determine whether the execution result could be evaluated before the operation unit performs the evaluation module to generate the score according to the execution result and the solution.

3. The online testing system according to claim 2, wherein if it is determined that the execution result cannot be evaluated, the operation unit records an error message to the one or more memory devices and transmits the error message to the external device.

4. The online testing system according to claim 1, wherein the operation unit is further configured to record the score to the one or more memory devices, and transmit the score to the external device.

5. (canceled)

6. The online testing system according to claim 1, wherein when the operation unit performs the program execution module to perform the computer program to generate the execution result according to the testing data, the program execution module enables the operation unit to call an agent program and executes the computer program by the agent program.

7. The online testing system according to claim 1, wherein when the operation unit performs the data generation module to generate the testing data and the solution corresponding to the testing data according to the raw data, the operation unit performs the data generation module to generate a training data according to the raw data.

8. The online testing system according to claim 7, wherein the data generation module divides the raw data into a first portion and a second portion, the data generation module generates the training data according to the first portion and generates the testing data and the solution according to the second portion.

9. The online testing system according to claim 7, wherein before the operation unit performs the program execution module to execute the computer program to generate the execution result according to the testing data, the operation unit is further configured to perform the program execution module to execute the computer program to obtain the computer program which has been trained according to the training data.

10. An online testing method for computer programs, wherein the online testing method is applicable to an online testing system having a closed operating environment, and comprises:
receiving a computer program from an external device by a communication unit of the online testing system;
performing a data generation module by an operation unit of the online testing system to generate a testing data and a solution corresponding to the testing data according to a raw data stored in a storage unit of the online testing system;
performing a program execution module by the operation unit to execute the computer program to generate an execution result according to the testing data; and
performing an evaluation module by the operation unit to generate a score according to the execution result and the solution,
wherein the method by which the data generation module generates the testing data is:
shuffling the raw data;
extracting part from raw data in quantity; or
a combination of the above.

11. The testing method according to claim 10, wherein before the evaluation module is performed by the operation unit to generate the score according to the execution result and the solution, the method further comprises:
performing a verification module by the operation module to determine whether the execution result could be evaluated.

12. The testing method according to claim 11, wherein if it is determined that the execution result cannot be evaluated, an error message is recorded to the storage unit and transmitted to the external device by the operation unit.

13. The testing method according to claim 10, further comprising:
recording the score to the storage unit and transmitting the score to the external device by the operation unit.

14. (canceled)

15. The testing method according to claim 10, wherein when the program execution module is performed by the operation unit to execute the computer program to generate the execution result according to the testing data, the program execution module enables the operation unit to call an agent program and executes the computer program by the agent program.

16. The testing method according to claim 10, wherein when the data generation module is performed by the operation unit to generate the testing data and the solution corresponding to the testing data according to the raw data, the operation unit performs the data generation module to generate a training data according to the raw data.

17. The testing method according to claim 16, wherein the data generation module divides the raw data into a first portion and a second portion, the data generation module generates the training data according to the first portion and generates the testing data and the solution according to the second portion.

18. The testing method according to claim 16, wherein before the program execution module is performed by the operation unit to execute the computer program to generate the execution result according to the testing data, the method further comprises:
performing the program execution module by the operation unit to execute the computer program to obtain the computer program which has been trained according to the training data.
